(19) United States
(12) Patent Application Publication
(10) Pub. No.: US 2025/0167494 A1
(43) Pub. Date: May 22, 2025

(54) HIGH-VOLTAGE CONNECTOR

(71) Applicant: CHANGCHUN JETTY AUTOMOTIVE PARTS CORPORATION, Changchun, Jilin (CN)

(72) Inventor: Chao WANG, Jilin (CN)

(21) Appl. No.: 18/841,110

(22) PCT Filed: Feb. 10, 2023
(86) PCT No.: PCT/CN2023/075352

§ 371 Date: Aug. 23, 2024

(30) Foreign Application Priority Data
Feb. 24, 2022 (CN) 202220400109.4

(51) Int. Cl. H01R 13/6599; H01R 13/504; H01R 24/20

(52) U.S. Cl. CPC H01R 13/6599; H01R 13/504; H01R 24/20

(57) ABSTRACT

The present disclosure relates to a high-voltage connector, including a plug portion and a socket portion which are pluggable, in which the plug portion includes a plug housing formed by injection molding of conductive plastic, the socket portion includes a socket housing formed by injection molding of the conductive plastic, at least one contact is provided on the plug housing, at least one elastic arm is provided in the socket housing, and the contact is capable of abutting against and making contact with the elastic arm; a plug cable is provided in the plug housing, an elastic connecting portion formed by injection molding of the conductive plastic is provided on the plug cable, and the elastic connecting portion is capable of abutting against and making contact with the plug housing; and a grounding structure is provided on the socket housing.

### RELATED APPLICATION

The present disclosure claims the priority of the Chinese utility model with an application number of CN202220400109.4, a patent title of “high-voltage connector”, and filed on Feb. 24, 2022, the entire content of which is incorporated herein by reference.

### TECHNICAL FIELD

The present disclosure relates to the technical field of connectors, and particularly to a high-voltage connector.

### BACKGROUND

In order to solve the electromagnetic shielding problem of conventional high-voltage connectors, it is usually necessary to design a metal shielding housing for electromagnetic shielding. But it is difficult for the metal shielding housing to achieve 360° seamless shielding, which leads to an electromagnetic leakage which interferes with the normal operation of other devices.

Therefore, based on years of experiences and practices in related industries, the inventor proposes a high-voltage connector to overcome the defects of the prior art.

### SUMMARY

The present disclosure aims to provide a high-voltage connector, in which a plug housing and a socket housing are both formed by injection molding of conductive plastic, a contact is in elastic contact with an elastic arm, an elastic connecting portion of a plug cable is formed by injection molding of the conductive plastic, and the high-voltage connector achieves an electromagnetic grounding function by means of a grounding structure, achieves a shielding function without physical shielding, and prevents an electromagnetic leakage from interfering with the normal operation of other devices.

The objective of the present disclosure is achieved as follows: a high-voltage connector, including a plug portion and a socket portion which are pluggable, in which the plug portion includes a plug housing formed by injection molding of conductive plastic, the socket portion includes a socket housing formed by injection molding of the conductive plastic, at least one contact is provided on the plug housing, at least one elastic arm is provided in the socket housing, and the contact is capable of abutting against and making contact with the elastic arm; a plug cable is provided in the plug housing, an elastic connecting portion formed by injection molding of the conductive plastic is provided on the plug cable, and the elastic connecting portion is capable of abutting against and making contact with the plug housing; and a grounding structure is provided on the socket housing.

In an optional embodiment of the present disclosure, the plug cable includes a wire core conductor, an outer wall of the wire core conductor is wrapped with a wire sheath portion, an outer wall of the wire sheath portion is provided with a shielding layer, and an outer wall of the shielding layer is wrapped with the elastic connecting portion.

In an optional embodiment of the present disclosure, the elastic connecting portion is an elastic buckle.

In an optional embodiment of the present disclosure, a positioning groove is provided in the plug housing, and the elastic buckle is capable of being clamped in the positioning groove.

In an optional embodiment of the present disclosure, both the number of elastic latches and the number of positioning grooves are two.

In an optional embodiment of the present disclosure, a first conical surface is provided on an outer wall of the elastic connecting portion, a second conical surface is provided in the plug housing, and the first conical surface is capable of abutting against and making contact with the second conical surface.

In an optional embodiment of the present disclosure, the grounding structure includes a panel connecting hole provided on the socket housing, a bushing is provided in the panel connecting hole, and the bushing is electrically connected to the socket housing.

In an optional embodiment of the present disclosure, a connecting through-hole is provided to penetrate through in the bushing.

In an optional embodiment of the present disclosure, the elastic arm is provided at a front part of the socket housing in an insertion direction and protrudes from a side wall of the socket housing, with a protruding height less than a gap distance between the socket housing and the plug housing.

In an optional embodiment of the present disclosure, the contact is provided at a bottom part of the plug housing in an insertion direction and protrudes from an inner wall of the plug housing, with a protruding height less than a gap distance between the plug housing and the socket housing.

Based on the above description, the high-voltage connector of the present disclosure has the following advantageous effects:

In the high-voltage connector of the present disclosure, the plug housing and the socket housing are both formed by injection molding of the conductive plastic to respectively constitute an integrated structure without splicing gaps, thereby achieving 360° seamless shielding, and preventing an electromagnetic leakage from interfering with the normal operation of other devices, while a special shielding layer is not needed for electromagnetic shielding; the plug housing and the socket housing are in elastic contact with the elastic arm through contacts, so that the plug housing and the socket housing are stably and conductively connected; the elastic connecting portion of the plug cable is formed by injection-molding of the conductive plastic, the plug cable abuts against and makes contact with the housing through the conductive plastic, and the high-voltage connector achieves an electromagnetic grounding function by means of the grounding structure, so that the high-voltage connector achieves a shielding function without physical shielding.

### BRIEF DESCRIPTION OF THE DRAWINGS

The following drawings are only for schematic illustration and explanation of the present disclosure, rather than limiting the scope of the present disclosure. In which:

FIG. 1 illustrates a structural diagram of a high-voltage connector of the present disclosure.

FIG. 2 illustrates a sectional view of a high-voltage connector of the present disclosure.

FIG. 3 illustrates a schematic diagram of a plug housing of the present disclosure.

FIG. 4 illustrates a schematic diagram of a socket housing of the present disclosure.

FIG. 5 illustrates a schematic diagram of a plug cable of the present disclosure.

FIG. 6 illustrates a sectional view of a plug cable of the present disclosure.

FIG. 7 illustrates a schematic diagram of a positioning groove and a second conical surface in a plug housing of the present disclosure.

### REFERENCE NUMERALS

100: high-voltage connector; 1: plug portion; 11: plug housing; 12: contact; 13: positioning groove; 14: second conical surface; 2: socket portion; 21: socket housing; 22: elastic arm; 23: bushing; 3: plug cable; 30: wire core conductor; 31: shielding layer; 32: elastic buckle; 33: first conical surface; 341: first layer of wire sheath; 342: second layer of wire sheath; 4: socket cable.

### DETAILED OF THE EMBODIMENTS

In order to have a clearer understanding of the technical features, objectives and effects of the present disclosure, specific embodiments of the present disclosure will now be described with reference to the drawings.

The specific embodiments of the present disclosure described here are only for the purpose of explaining the present disclosure, and should not be construed as limiting the present disclosure in any way. Under the teaching of the present disclosure, persons skilled in the art can conceive any possible variation based on the present disclosure, which should be regarded as falling within the scope of the present disclosure. It should be noted that when an element is referred to as being “provided” on another element, it may be directly on another element or there may be an intervening element. When an element is regarded as being “connected” to another element, it may be directly connected to another element or there may be an intervening element. The terms ‘mount’ and ‘connect’ should be understood in a broad sense. For example, a connection may be a mechanical connection or an electrical connection, or an internal communication between two elements, or a direct connection, or an indirect connection through an intermediate medium. For persons of ordinary skills in the art, the specific meanings of the above terms can be understood according to the specific conditions. The terms “vertical”, “horizontal”, “upper”, “lower”, “left”, “right” and similar expressions used herein are for illustration only rather than indicating a unique embodiment.

Unless otherwise defined, all technical and scientific terms used herein have the same meanings as those commonly understood by persons skilled in the art of the present disclosure. The terms used in the Specification of the present disclosure are only for the purpose of describing the specific embodiments, rather than limiting the present disclosure. The term “and/or” used herein includes any and all combinations of one or more of the related items listed.

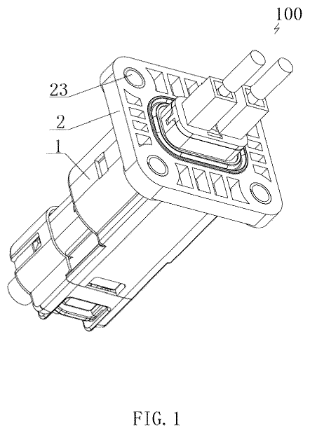

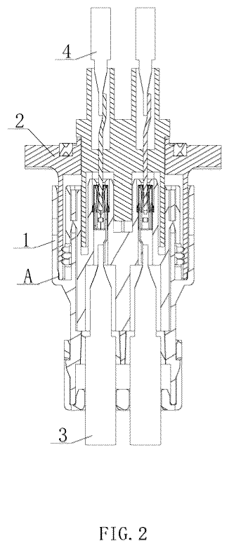

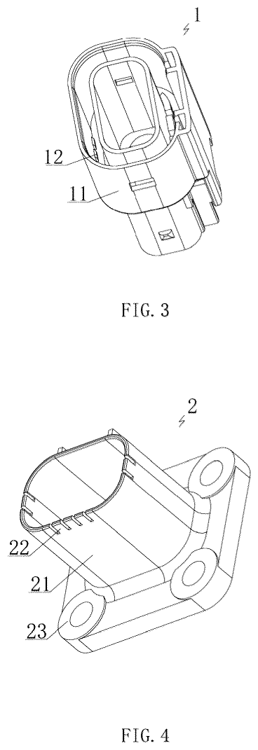

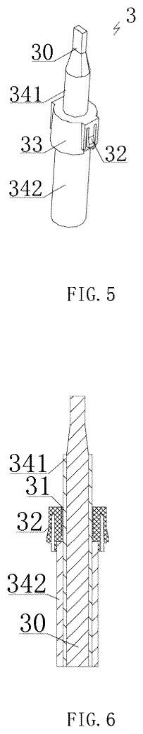

As illustrated in FIGS. 1 to 7, the present disclosure provides a high-voltage connector 100, including a plug portion 1 and a socket portion 2 which are pluggable, in which the plug portion includes a plug housing 11 formed by injection molding of conductive plastic, and the socket portion includes a socket housing 21 formed by injection molding of the conductive plastic. As illustrated in FIG. 3, at least one contact 12 is provided on the plug housing 11 and as illustrated in FIG. 4, at least one elastic arm 22 is provided in the socket housing 21, and the contact 12 is capable of abutting against and making contact with the elastic arm 22. As illustrated in FIG. 2, area A is a sectional area where the contact point 12 is in contact with the elastic arm 22 to realize the contact between the plug portion 1 and the socket portion 2.

A plug cable 3 is provided in the plug housing 11, a socket cable 4 is provided in the socket housing 21, and the plug cable 3 and the socket cable 4 are capable of being in conductive communication through a conductive reed (the prior art); the plug cable 3 is provided with the elastic connecting portion formed by injection molding of conductive plastic, and the elastic connecting portion is capable of abutting against and making contact with the plug housing 11; the socket housing 21 is provided with a grounding structure, a conduction is achieved by the elastic connecting portion formed by injection molding of conductive plastic, the plug housing 11 and the socket housing 21, and finally grounding is made by the grounding structure to realize electromagnetic shielding.

The conductive plastic is a functional polymer material made of resin and conductive substances which are mixed and subjected to plastic processing. Most conductive plastics are made by doping a high concentration of filamentous carbon black and completely carbonized compound into an original insulating material. The conductive plastic combines the electrical conductivity of metal (i.e., a voltage is applied across a material and current flows through the material) with various properties of plastics (i.e., the molecules of the material are composed of many tiny and repeated structural units). The conductive plastic is an ideal shielding material, which can be used as a housing of an electronic device to shield electromagnetic waves. Compared with traditional conductive materials, the conductive plastic is lighter, easier to be molded and processed, and corrosion-resistant, easy to adjust a resistance and has a low total cost

In the high-voltage connector of the present disclosure, the plug housing and the socket housing are both formed by injection molding of the conductive plastic to respectively constitute an integrated structure without splicing gaps, thereby achieving 360° seamless shielding, and preventing an electromagnetic leakage from interfering with the normal operation of other devices, while a special shielding layer is not needed for electromagnetic shielding; the plug housing and the socket housing are in elastic contact with the elastic arm through contacts, so that the plug housing and the socket housing are stably conductively connected; the elastic connecting portion of the plug cable is formed by injection-molding of the conductive plastic, the plug cable abuts against and makes contact with the housing through the conductive plastic, and the high-voltage connector achieves an electromagnetic grounding function by means of the grounding structure, so that the high-voltage connector achieves a shielding function without physical shielding.

Further, as illustrated in FIGS. 2, 5 and 6, the plug cable 3 includes a wire core conductor 30, an outer wall of the wire core conductor is wrapped with a wire sheath portion (the prior art), an outer wall of the wire sheath portion is provided with a shielding layer 31 (the prior art), and an outer wall of the shielding layer 31 is wrapped with the elastic connecting portion. In a specific embodiment of the present disclosure, the wire sheath portion includes a first layer of wire sheath 341 and a second layer of wire sheath 342, and the shielding layer 31 is provided on an outer wall of the first layer of wire sheath 341 above the second layer of wire sheath 342.

Further, the elastic connecting portion is an elastic buckle 32.

In a specific embodiment of the present disclosure, there are two of the plug cables 3. The elastic connecting portion on the plug cable 3 is integrally injection-molded to ensure the contact between the cable and the conductive plastic, so that the plug cable 3 is in contact with and attached to the plug housing 11 through the conductive plastic.

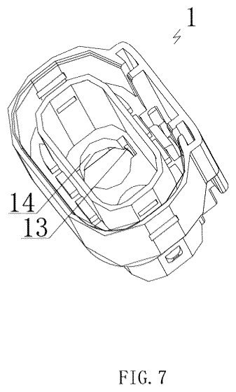

Further, as illustrated in FIG. 7, a positioning groove 13 is provided in the plug housing 11, and the elastic buckle 32 is capable of being clamped in the positioning groove 13. In a specific embodiment of the present disclosure, there may be two of the elastic buckles 32 and two of the positioning grooves 13.

Further, as illustrated in FIGS. 2, 5, 6 and 7, a first conical surface 33 is provided on an outer wall of the elastic connecting portion, a second conical surface 14 is provided in the plug housing 11, and the first conical surface 33 is capable of abutting against and making contact with the second conical surface 14. When mounted in place, the first conical surface 33 is capable of abutting against and making contact with the second conical surface 14 to form a secondary contact engagement between the elastic connecting portion integrally injection-molded and the plug housing 11.

Further, as illustrated in FIGS. 1 and 4, the grounding structure includes a panel connecting hole provided on the socket housing 21, a bushing 23 is provided in the panel connecting hole, and the bushing 23 is electrically connected to the socket housing 21.

Further, a connecting through-hole is provided in the bushing 23 to penetrate therethrough. The bushing 23 on the socket housing 21 is connected to the mounting panel (the prior art) by screws to achieve grounding.

In a specific embodiment of the present disclosure, there are four of panel connecting holes and four of bushings, and the panel connecting holes and the bushings are provided on the socket housing at intervals in a circumferential direction.

In this embodiment, the elastic arm 22 is provided at a front part of the socket housing 21 in an insertion direction and protrudes from a side wall of the socket housing, with a protruding height less than a gap distance between the socket housing 21 and the plug housing 11.

In this embodiment, the contact 12 is provided at a bottom part of the plug housing 11 in an insertion direction and protrudes from an inner wall of the plug housing 11, with a protruding height less than a gap distance between the plug housing 11 and the socket housing 21.

Based on the above description, the high-voltage connector of the present disclosure has the following advantageous effects:

In the high-voltage connector of the present disclosure, the plug housing and the socket housing are both formed by injection molding of the conductive plastic to respectively constitute an integrated structure without splicing gaps, thereby achieving 360° seamless shielding, and preventing an electromagnetic leakage from interfering with the normal operation of other devices, while a special shielding layer is not needed for electromagnetic shielding; the plug housing and the socket housing are in elastic contact with the elastic arm through contacts, so that the plug housing and the socket housing are stably and conductively connected; the elastic connecting portion of the plug cable is formed by injection-molding of the conductive plastic, the plug cable abuts against and makes contact with the housing through the conductive plastic, and the high-voltage connector achieves an electromagnetic grounding function by means of the grounding structure, so that the high-voltage connector achieves a shielding function without physical shielding.

Those described above are just schematic embodiments of the present disclosure, rather than limitations thereto. Any equivalent substitution or amendment made by persons skilled in the art without deviating from the concept and principle of the present disclosure should fall within the protection scope of the present disclosure.

1. A high-voltage connector, comprising a plug portion and a socket portion which are pluggable, wherein the plug portion comprises a plug housing formed by injection molding of conductive plastic, the socket portion comprises a socket housing formed by injection molding of the conductive plastic, at least one contact is provided on the plug housing, at least one elastic arm is provided in the socket housing, and the contact is capable of abutting against and making contact with the elastic arm; a plug cable is provided in the plug housing, an elastic connecting portion formed by injection molding of the conductive plastic is provided on the plug cable, and the elastic connecting portion is capable of abutting against and making contact with the plug housing; and a grounding structure is provided on the socket housing.

2. The high-voltage connector according to claim 1, wherein the plug cable comprises a wire core conductor, an outer wall of the wire core conductor is wrapped with a wire sheath portion, an outer wall of the wire sheath portion is provided with a shielding layer, and an outer wall of the shielding layer is wrapped with the elastic connecting portion.

3. The high-voltage connector according to claim 2, wherein the elastic connecting portion is an elastic buckle.

4. The high-voltage connector according to claim 3, wherein a positioning groove is provided in the plug housing, and the elastic buckle is capable of being clamped in the positioning groove.

5. The high-voltage connector according to claim 4, wherein both the number of elastic latches and the number of positioning grooves are two.

6. The high-voltage connector according to claim 2, wherein a first conical surface is provided on an outer wall of the elastic connecting portion, a second conical surface is provided in the plug housing, and the first conical surface is capable of abutting against and making contact with the second conical surface.

7. The high-voltage connector according to claim 1, wherein the grounding structure comprises a panel connecting hole provided on the socket housing, a bushing is provided in the panel connecting hole, and the bushing is electrically connected to the socket housing.

8. The high-voltage connector according to claim 7, wherein a connecting through-hole is provided to penetrate through the bushing.

9. The high-voltage connector according to claim 1, wherein the elastic arm is provided at a front part of the socket housing in an insertion direction and protrudes from a side wall of the socket housing, with a protruding height less than a gap distance between the socket housing and the plug housing.

10. The high-voltage connector according to claim 1, wherein the contact is provided at a bottom part of the plug housing in an insertion direction and protrudes from an inner wall of the plug housing, with a protruding height less than a gap distance between the plug housing and the socket housing.
